(19) United States
(12) Patent Application Publication
(10) Pub. No.: US 2017/0220455 A1
(43) Pub. Date: Aug. 3, 2017

(54) TEST CASE GENERATION USING A CONSTRAINT GRAPH SOLVER

(71) Applicant: Mentor Graphics Corporation, Wilsonville, OR (US)

(72) Inventors: Ahmed Badran, Canby, OR (US); Sudhir Kadkade, Lake Oswego, OR (US)

(21) Appl. No.: 15/010,117

(22) Filed: Jan. 29, 2016

(51) Int. Cl. G06F 11/36

(52) U.S. Cl. CPC G06F 11/3684

(57) ABSTRACT

The application discloses a computing system to analyze a program to generate a control flow graph representing paths capable of being traversed through the program during execution. The computing system can translate the control flow graph into a constraint graph representation of the program. The computing system can utilize a constraint solver on the constraint graph to identify a set of test values associated with a coverage definition. The set of test values can prompt the program, during execution, to be exercised based on the coverage definition provided to the test program generation tool 300. The computing system can generate a test program configured to provide the set of input variable values to the program.

### TECHNICAL FIELD

This application is generally related to software testing and, more specifically, to test case generation using a constraint graph solver.

### BACKGROUND

Software programs often include “bugs” or defects, which can cause errors in software functionality when the software programs are executed. One technique to identify these “bugs” or defects is to generate a test program that, when executed with the software program, can provide input to the software program. This input from the test program can prompt execution of the various portions of the software program, the results of which can be compared to expected results to determine if “bugs” or defects exist in the software program. The test program may also be utilized to exercise the software programs, which is often called coverage.

Testing functionality of software programs is often performed by programmers manually writing targeted test cases that can be incorporated into a test program. These targeted test cases, when executed, can test how these software programs will behave in very specific conditions. This manual-nature of this test case generation renders software testing difficult and time consuming. As software programs become even more complex, these issues become more exacerbated.

In an attempt to automate software testing, some techniques select values for input variables randomly. While having values of input variables vary randomly can automate some of software testing, the randomization of the variables often fails to exercise different portions of the program and over-exercises other portions of the program. Thus, randomizing variable input values during software testing can leave portions of the program untested, while inefficiently testing other portions of the program repetitively.

Another approach for testing software selects values for input variables from a pre-specified set of values, which can be more deterministic than the completely random approach. This approach, however, still has programmers manually analyzing the program to determine what values of the input variable would be permissible, what values will exercise different parts of the program, or the like. Thus, this partial automation of the previously manual process of generating test cases remains a predominately manual task, which is complicated and time consuming.

### SUMMARY

This patent application discloses a computing system to analyze a program to generate a control flow graph representing paths capable of being traversed through the program during execution. The computing system can translate the control flow graph into a constraint graph representation of the program. The computing system can utilize a constraint solver on the constraint graph to identify a set of test values associated with a coverage definition. The set of test values can prompt the program, during execution, to be exercised based on the coverage definition provided to the test program generation tool 300. The computing system can generate a test program configured to provide the set of input variable values to the program. Embodiments of test program generation with a constraint solver will be described below.

### DESCRIPTION OF THE DRAWINGS

FIGS. 1 and 2 illustrate an example of a computer system of the type that may be used to implement various embodiments of the invention.

FIG. 3 illustrates an example test program generation tool to analyze a program and automatically generate a test program based on a coverage definition according to various embodiments of the invention.

FIG. 4 illustrates a flowchart showing example test program generation based on program analysis and coverage definition according to various examples of the invention.

FIGS. 5A-5C illustrate an example of a conditional construct code portion, a control flow graph, and a corresponding constraint graph according to various embodiments of the invention.

FIGS. 6A-6C illustrate another example of a conditional construct code portion, a control flow graph, and a corresponding constraint graph according to various embodiments of the invention.

FIGS. 7A-7C illustrate yet another example of a conditional construct code portion, a control flow graph, and a corresponding constraint graph according to various embodiments of the invention.

### DETAILED DESCRIPTION

### Illustrative Operating Environment

The execution of software programs according to embodiments of the invention may be implemented using computer-executable software instructions executed by one or more programmable computing devices. Because these embodiments of the invention may be implemented using software instructions, the components and operation of a programmable computer system on which various embodiments of the invention may be employed will first be described.

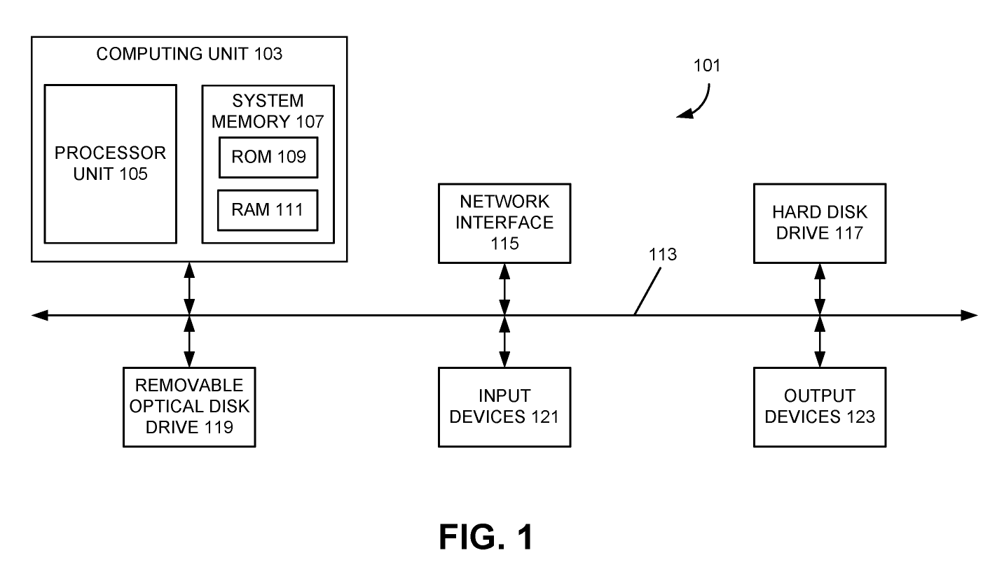

Various examples of the invention may be implemented through the execution of software instructions by a computing device 101, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices 117-123. For example, the processing unit 105 or the system memory 107 may be directly or indirectly connected to one or more additional memory storage devices, such as a hard disk drive 117, which can be magnetic and/or removable, a removable optical disk drive 119, and/or a flash memory card. The processing unit 105 and the system memory 107 also may be directly or indirectly connected to one or more input devices 121 and one or more output devices 123. The input devices 121 may include, for example, a keyboard, a pointing device (such as a mouse, touchpad, stylus, trackball, or joystick), a scanner, a camera, and a microphone. The output devices 123 may include, for example, a monitor display, a printer and speakers. With various examples of the computing device 101, one or more of the peripheral devices 117-123 may be internally housed with the computing unit 103. Alternately, one or more of the peripheral devices 117-123 may be external to the housing for the computing unit 103 and connected to the bus 113 through, for example, a Universal Serial Bus (USB) connection.

With some implementations, the computing unit 103 may be directly or indirectly connected to a network interface 115 for communicating with other devices making up a network. The network interface 115 can translate data and control signals from the computing unit 103 into network messages according to one or more communication protocols, such as the transmission control protocol (TCP) and the Internet protocol (IP). Also, the network interface 115 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 101 is illustrated as an example only, and it not intended to be limiting. Various embodiments of the invention may be implemented using one or more computing devices that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

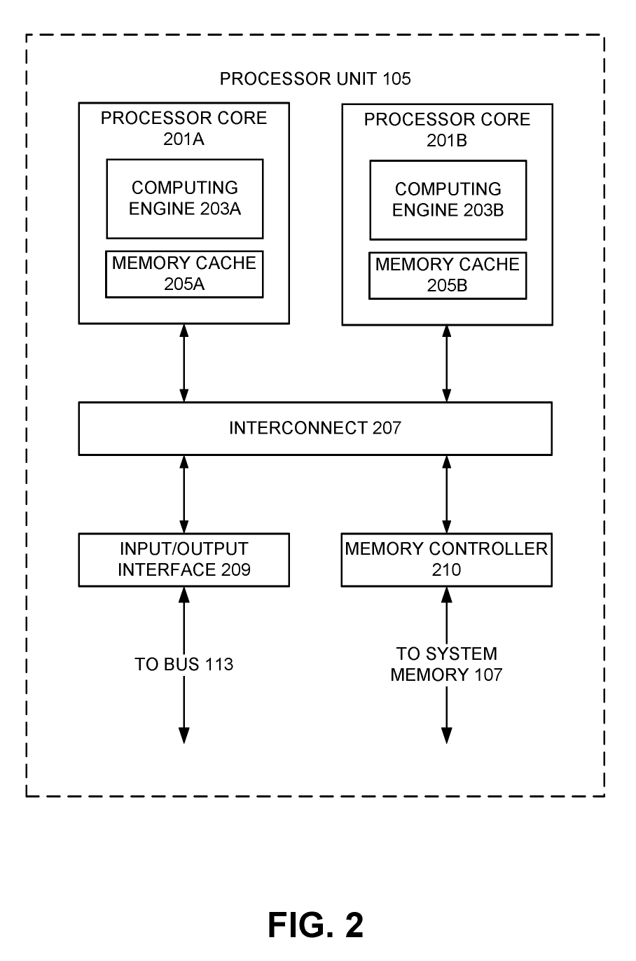

With some implementations of the invention, the processor unit 105 can have more than one processor core. Accordingly, FIG. 2 illustrates an example of a multi-core processor unit 105 that may be employed with various embodiments of the invention. As seen in this figure, the processor unit 105 includes a plurality of processor cores 201A and 201B. Each processor core 201A and 201B includes a computing engine 203A and 203B, respectively, and a memory cache 205A and 205B, respectively. As known to those of ordinary skill in the art, a computing engine 203A and 203B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203A and 203B may then use its corresponding memory cache 205A and 205B, respectively, to quickly store and retrieve data and/or instructions for execution.

Each processor core 201A and 201B is connected to an interconnect 207. The particular construction of the interconnect 207 may vary depending upon the architecture of the processor unit 105. With some processor cores 201A and 201B, such as the Cell microprocessor created by Sony Corporation, Toshiba Corporation and IBM Corporation, the interconnect 207 may be implemented as an interconnect bus. With other processor units 201A and 201B, however, such as the Opteron™ and Athlon™ dual-core processors available from Advanced Micro Devices of Sunnyvale, Calif., the interconnect 207 may be implemented as a system request interface device. In any case, the processor cores 201A and 201B communicate through the interconnect 207 with an input/output interface 209 and a memory controller 210. The input/output interface 209 provides a communication interface to the bus 113. Similarly, the memory controller 210 controls the exchange of information to the system memory 107. With some implementations of the invention, the processor unit 105 may include additional components, such as a high-level cache memory accessible shared by the processor cores 201A and 201B. It also should be appreciated that the description of the computer network illustrated in FIG. 1 and FIG. 2 is provided as an example only, and it not intended to suggest any limitation as to the scope of use or functionality of alternate embodiments of the invention.

Test Case Generation using a Constraint Graph Solver

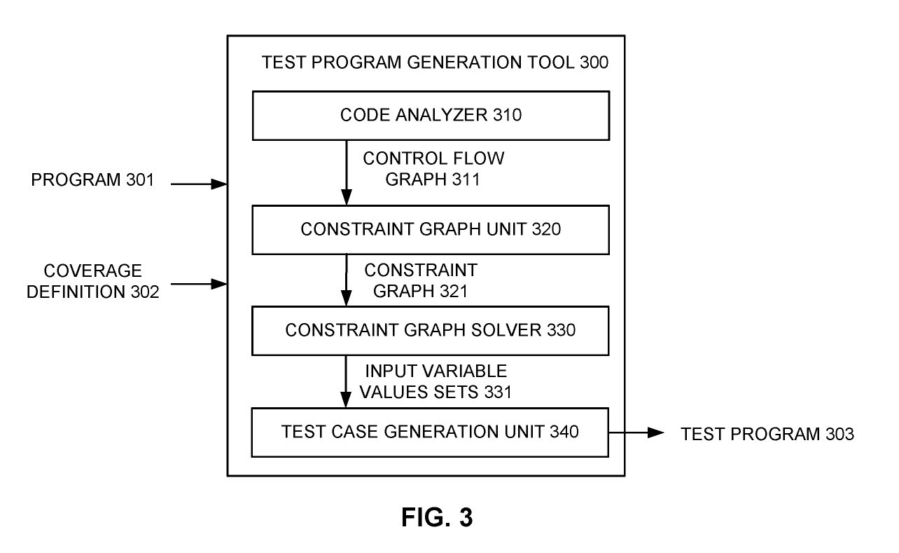

FIG. 3 illustrates an example test program generation tool 300 to analyze a program 301 and automatically generate a test program 303 based on a coverage definition 302 according to various embodiments of the invention. Referring to FIG. 3, the test program generation tool 300 can include a code analyzer 310 to receive a program 301 to be tested. The program 301 can be written in a C or C++ programming language, a hardware description language (HDL), or the like. In some embodiments, the code analyzer 310 can be a compiler or a portion thereof capable of generating a control flow graph 311 from the source code of the program 301.

The code analyzer 310 can parse the program 301 to determine the syntactic structure of the source code in the program 301, and generate an abstract syntax tree (AST) representation of the syntactic structure of the program 301. Each node of the abstract syntax tree can denote a construct occurring in the source code. The code analyzer 310, in some embodiments, can convert the abstract syntax tree into the control flow graph 311. Each node in the control flow graph 311 can correspond to a basic block in the program. A basic block in source code can represent a linear sequence of computer statements or instructions with a single entry point and a single exit point. For example, execution of a basic block can start with a first statement or instruction in the basic block, progress linearly along the source code statements in the basic block, and then complete with execution of a last statement or instruction in the basic block. The nodes in the control flow graph 311 can have directed edges or arrows to describe a sequence which subsequent basic blocks can be executed. A control path in the control flow graph 311 can describe an executable-sequence of basic blocks through the source code of the program 301.

The test program generation tool 300 can include a constraint graph unit 320 to generate a constraint graph 321 representation of the program 301. In some embodiments, the constraint graph unit 320 can generate the constraint graph 321 by converting or translating the control flow graph 311 into the constraint graph 321. The constraint graph unit 320 also may generate the constraint graph 321 directly from the program 301.

The constraint graph unit 320 can identify features of the program 301, such as input variables to functions, basic blocks of source code, expressions that cause alternative basic blocks to be executed, variables in these expressions, assignments to the variables, function declarations, function calls, looping constructs, conditional constructs, or the like. The constraint graph unit 320 can convert the identified features into elements of the constraint graph 321, for example, so different control flow paths between basic blocks in the program 301 can be represented by different constraint paths in the constraint graph 321.

The constraint graph unit 320, in some embodiments, can identify expressions that can cause control to follow one of multiple possible paths in the program 301, convert the identified expressions into constraints in the constraint graph 321 corresponding to the execution of different paths through the constraint graph 321. For example, a condition in an if-statement within the program can cause control to flow into a “then” code block or to an “else” code block depending on whether the condition is true or false.

The constraint graph unit 320, in some embodiments, can identify variables in these expressions. The constraint graph unit 320 can represent the identified variables with different variable vertexes in the constraint graph 321. The program 301 can have a variety of different types of variables in these expressions. For example, the program 301 may include variables having a scalar data type, which can be assigned any value defined by the scalar data type or system input specification. The constraint graph unit 320, after identifying a presence of a scalar variable in the program 301, can represent the scalar variable with a variable vertex in the constraint graph 321.

In another example, the program 301 may include variables having a structure data type, meaning they can include multiple member variables. The constraint graph unit 320 can represent the structure variables in the constraint graph 321 with a different vertex corresponding to each of the member variables. The member variables also can be assigned any value defined by the scalar data type or system input specification.

In some embodiments, the program 301 can include a volatile variable, for example, the value of which can be set outside of the control of the program 301. For example, a variable can have its value mapped to a hardware register, which may be changed externally from execution of the program 301. The constraint graph unit 320, after identifying a presence of a volatile variable in the program 301, can represent the volatile variable with a variable vertex in the constraint graph 321.

Once the constraint graph unit 320 identifies one or more variables in an expression, the constraint graph unit 320 can determine whether any these variables are dependent on other variables in the control paths of the constrain graph 321, or whether any other variables are dependent on the identified variables. In some embodiments, the constraint graph unit 320 can recursively analyze the program 301, its expressions, and basic blocks to determine variable dependency along the different control flow paths.

The program 301 can include assignment statements, each of which can assign at least one value to identified variables. The assigned values of the variable can be represented as constraints in the constraint graph 321 in terms of the variable vertex corresponding to the variable in the program 301. These constraints can cause the vertexes representing the variables in the constraint graph 321 to be bound to the assigned values from this point onwards while traversing the constraint graph 321. In other words, an assignment to a variable in the program 301 can be represented by a constraint on possible values that the vertex for the variable can take in the constraint graph 321. Since a value of a volatile variable can change outside of control of the execution of the program 301, the constraint graph unit 320 can read the value of the volatile variable and re-compute any constraints from this point on the constraint graph 321.

When the program 301 includes multiple assignments to a variable, the constraint graph unit 320 can generate a new vertex corresponding to the variable in the constraint graph 321 for each of the assignments. The value of this new vertex can be constrained to the expression being assigned to the variable in the program 301. When the expression in the program 301 includes a variable, the constraint in the constraint graph 321 can be created in terms of the vertexes corresponding to the variable in the constraint graph 321.

When converting an expression in the program 301 into a constraint in the constraint graph 321, the constraint graph unit 320 can determine which of possibly several vertexes, due to possibly multiple assignments or multiple paths taken, in the constraint graph 321 correspond to a variable in the expression. In some embodiments, the constraint graph unit 320 can insert markers in the different points in the constraint graph 321 corresponding to an assigned variable. By checking values associated with the markers, and searching the control paths backwards, the constraint graph unit 320 can detect which of several paths in the constraint graph 321 were taken and thus which of several vertexes corresponding to the variable in the constraint graph 321 currently hold the value of the variable.

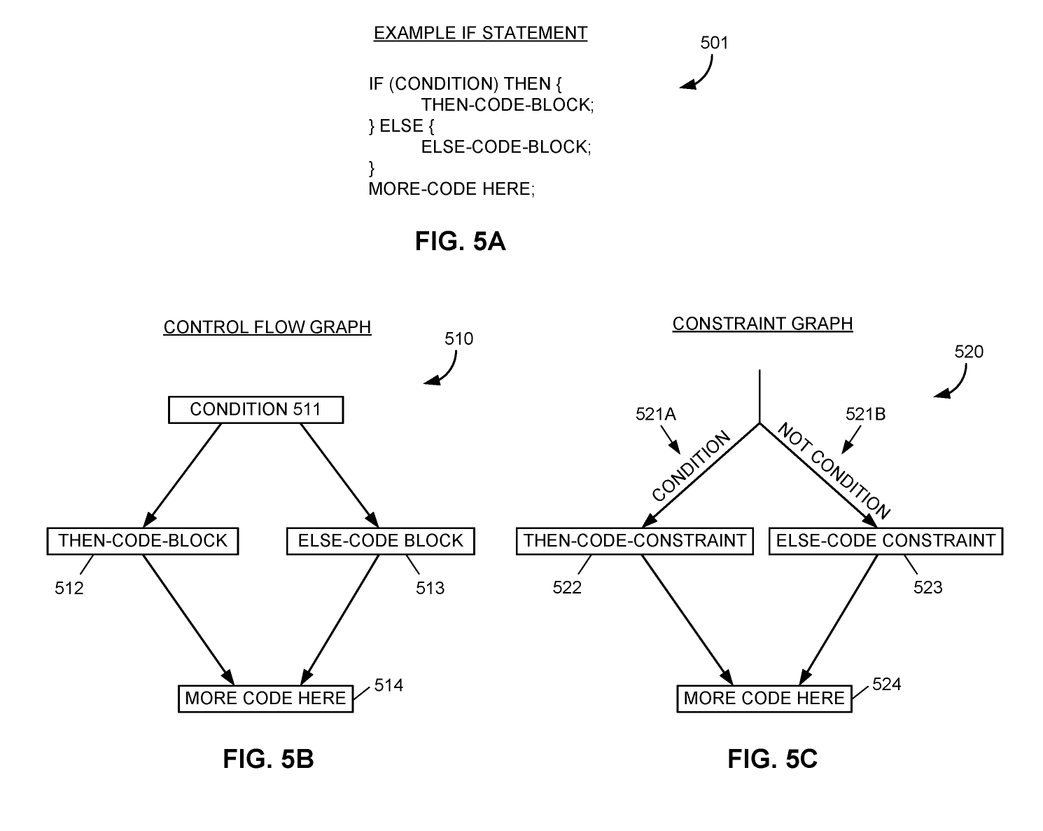

The constraint graph unit 320 can generate multiple paths in the constraint graph 321 based on a presence of a conditional construct in the program 301. The conditional construct in the program 301 can cause control flow through the program 301 to take one of several paths. Each of these paths can be constrained in the constraint graph 321 by a constraint that corresponds to the conditional construct in the program 301. Examples of conditional construct code portions, control flow graphs, and corresponding constraint graphs will be described below in FIGS. 5A-5C, 6A-6C, and 7A-7C.

FIGS. 5A-5C illustrates an example code portion 501, a control flow graph 510, and a corresponding constraint graph 520 according to various embodiments of the invention. Referring to FIGS. 5A-5C, the code portion 501 can include an expression that can cause control to follow one of multiple different paths. For example, the code portion 501 includes an if-statement, which based on a state or value of a condition, can cause code execution to flow to a code block corresponding to a then-statement or to a code block corresponding to an else-statement.

The control flow graph 510 shown in FIG. 5B can include nodes corresponding to basic blocks of the code portion 501, such as a condition node 511, a then-code-block 512, an else-code-block 513, and a more code here block 514. The control flow graph 510 can couple the basic blocks of the code portion 501 with directed edges or arrows to represent execution paths capable of being traversed through the code portion 501. For example, execution of the code portion 501 can begin with the basic block corresponding to the condition node 511, based on the execution of the condition node 511, execution proceeds down a first path including the then-code-block 512 and the more code here block 514, or proceeds down a second path including the else-code-block 513 and the more code here block 514.

The constraint graph 520 shown in FIG. 5C can include nodes corresponding to constraints associated with basic blocks of the code portion 501, such as a then-code-constraint 522, an else-code-constraint 523, and a more code here constraint 524. These constraints 522-524 can define different paths of the code portion 501. In this example, the constraint graph 520 can include a pair of variables 521A and 521B associated with the condition in the code portion 501, and in the condition node 511 of the control flow graph 510. The variables 521A and 521B can define two different paths: a first path including the then-code-constraint 522 and the more code here constraint 524, or proceeds down a second path including the else-code-constraint 523 and the more code here constraint 524.

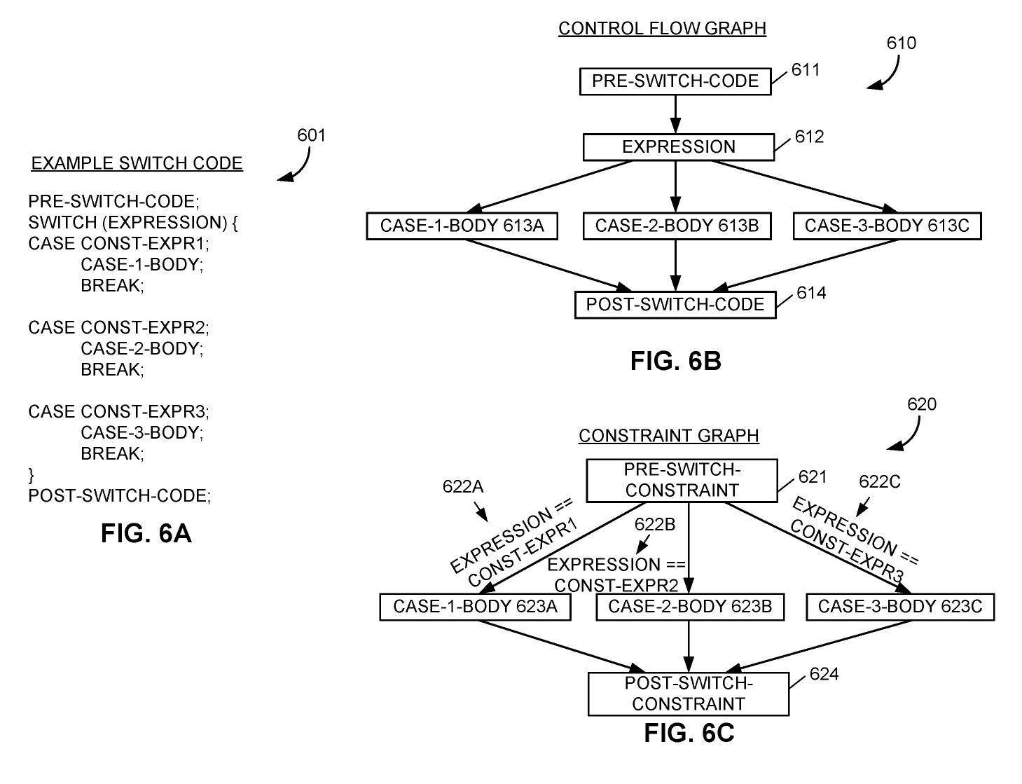

FIG. 6A-6C illustrates an example of a conditional construct code portion 601, a control flow graph 610, and a corresponding constraint graph 620 according to various embodiments of the invention. Referring to FIG. 6A, the code portion 601 can include a conditional construct that can cause control to follow one of multiple different paths. For example, the code portion 601 includes a switch-statement, which based on a state or value of an expression, can cause code execution to flow to a code block corresponding to one of multiple different case-statements.

The control flow graph 610 shown in FIG. 6B can include nodes corresponding to basic blocks of the code portion 601, such as a pre-switch-code block 611, an expression node 612, case-1-body block 613A, case-2-body block 613B, case-3-body block 613C, and post-switch-code 614. The control flow graph 610 can couple the basic blocks of the code portion 601 with directed edges or arrows to represent execution paths capable of being traversed through the code portion 601. For example, execution of the code portion 601 can begin with the basic block corresponding to the pre-switch-code block 611, proceed to the expression 612, and then based on the execution of the expression 612, execution proceeds to post-switch-code block 614 through one of three different paths, i.e., via case-1-body block 613A, case-2-body block 613B, or case-3-body block 613C.

The constraint graph 620 shown in FIG. 6C can include nodes corresponding to constraints associated with basic blocks of the code portion 601, such as a pre-switch-constraint(s) 621, case-1-body constraint(s) 623A, case-2-body constraint(s) 623B, case-3-body constraint(s) 623C, and post-switch-constraint 624. These constraints 621, 623A-623C, and 624 can define different paths of the code portion 601. In this example, the constraint graph 620 can include a first path having case-1-body constraint(s) 623A when the expression in the code portion 601 corresponds to variable 622A or const-expr1, a second path having case-2-body constraint(s) 623B when the expression in the code portion 601 corresponds to variable 622B or const-expr2, and a third path having case-3-body constraint(s) 623C when the expression in the code portion 601 corresponds to variable 622C or const-expr3.

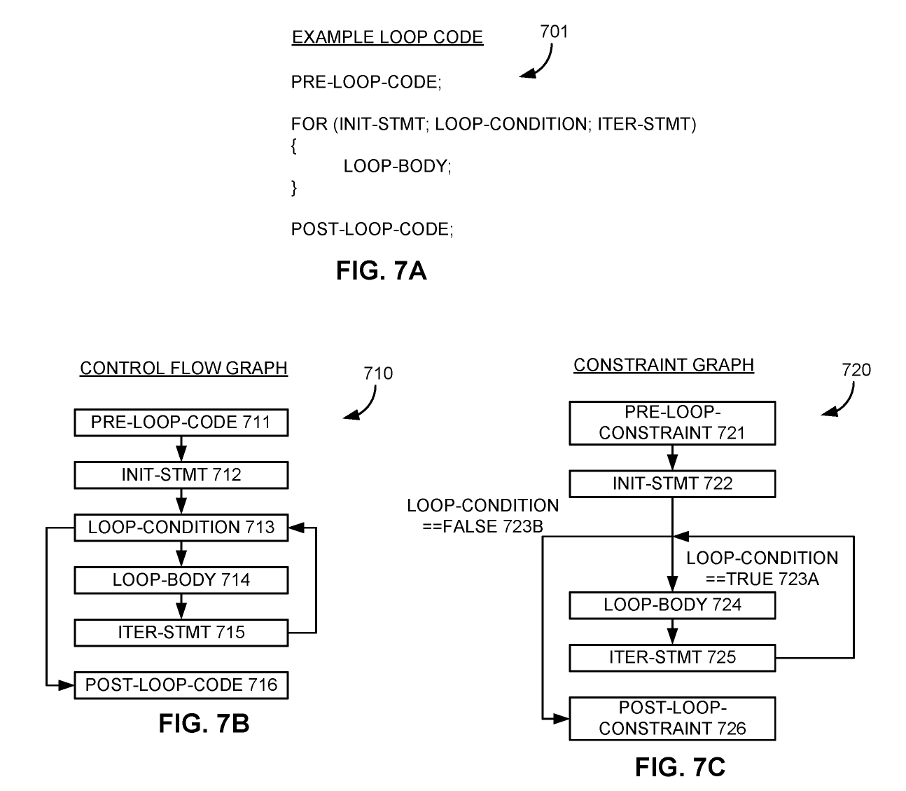

FIGS. 7A-7C illustrate yet another example conditional construct code portion 701, a control flow graph 710, and a corresponding constraint graph 720 according to various embodiments of the invention. Referring to FIG. 7A, the code portion 701 can include a conditional construct that can cause control to follow one of multiple different paths. For example, the code portion 701 includes a loop-statement, which based on a state or value of a loop condition, can cause code execution to loop through a common set of one or more code blocks while the loop condition is true.

The control flow graph 710 shown in FIG. 7B can include nodes corresponding to basic blocks of the code portion 701, such as a pre-loop-code block 711, an initial statement block 712, loop-condition block 713, a loop-body block 714, an iterator statement block 715, and post-loop-code block 716. The control flow graph 710 can couple the basic blocks of the code portion 701 with directed edges or arrows to represent execution paths capable of being traversed through the code portion 701. For example, execution of the code portion 701 can begin with the basic block corresponding to the pre-loop-code block 711, proceed to the initial statement block 712 and the loop-condition block 713, and then based on the execution of the loop-condition block 713, execution either proceeds to loop through the loop-body block 714 and iterator statement block 715, before returning the loop-condition block 713, or proceeds to the post-loop-code block 716.

The constraint graph 720 shown in FIG. 7C can include nodes corresponding to constraints associated with basic blocks of the code portion 701, such as a pre-loop-code constraint 721, an initial statement constraint(s) 722, a loop-body constraint(s) 724, an iterator statement constraint(s) 725, and post-loop-code constraint 726. These constraints 721, 722, and 724-726 can define a loop through the loop-body constraint 724 and the iterator statement constraint 725, and define an exit from the loop to the post-loop-code constraint 726. In this example, the constraint graph 720 can include a first path that loops through the loop-body constraint 724 and the iterator statement constraint 725 when the constraint 723A has a loop-condition equal to true, and include a second path that proceeds to the post-loop-constraint 726 when the constraint 723B has a loop-condition equal to false.

Referring back to FIG. 3, since many programs 301 include routines that can call sub-routines or functions, the constraint graph unit 320, in some embodiments, can generate sub-constraint graphs for the sub-routines or functions in the program 301 and stitch them into the constraint graph 321 associated with the routine calling the sub-routines. The constraint graph unit 320 can identify function call points in the program 301 and, at the function call points relative to the constraint graph 321, instantiate the sub-constraint graphs corresponding to functions associated with the function call points.

Each sub-routine or function can have an entry basic block corresponding to a first block executed in the function, and have an exit basic block corresponding to a last block executed before the function returns from its call. In some embodiments, the constraint graph unit 320 can convert function variable instances and basic blocks into the sub-constraint graph. In addition to the local variables in a function, the constraint graph unit 320, in some embodiments, can create vertexes in the sub-constraint graph to represent function parameters. If the function has a return value, the constraint graph unit 320 may create a vertex to represent the return value in constraint graph 321 and generate a constraint on the value of the vertex to constrain it to the return value in the called function.

The test program generation tool 300 can include a constraint graph solver 330 to receive a coverage definition 302, which can correspond to a coverage goal for the program 301. For example, a coverage goal described in the coverage definition 302 may be to cover all paths in the program 301 or a portion thereof. Another coverage goal described in the coverage definition 302 may be to cover each line in the program 301 or a portion thereof.

The constraint graph solver 330 can utilize the coverage definition 302 to identify at least one input variable value set 331 that, when input during execution of the program 301, can prompt the program 301 to execute portions of its source code that achieve the coverage goal described in the coverage definition 302. In some embodiments, the constraint graph solver 330 can be a graphical-based constraint solver, such as Questa inFact™ manufactured by Mentor Graphics Corporation. Since the constraint graph 321 reflects the structure of the program, solving for input variable values that cover the constraint graph 321 can also be utilized during program execution to similarly cover the program 301.

The test program generation tool 300 can include a test case generation unit 340 to utilize the input variable value set 331 in a generation of a test program 303. The test program 303 can provide the input variable values identified by the constraint graph solver 330 to the program 301. In some embodiments, the constraint graph solver 330 can identify all of the input variable values in the input variable value set 331, and the test program 303 can provide those input variable values to the program 303. In other embodiments, the test program 303 can provide one or more of the input variable values to the program 301 as the constraint graph solver 330 identifies them. For example, the constraint graph solver 330 may analyze a portion of the constraint graph 331 to identify input variable values corresponding to that portion of the constraint graph 331, and the test program 303 can provide the input variable values to the portion of the program 301 corresponding to the portion of the constraint graph 331. The input variable values can prompt the program 301, during execution, to be exercised based on the coverage definition 302 provided to the test program generation tool 300.

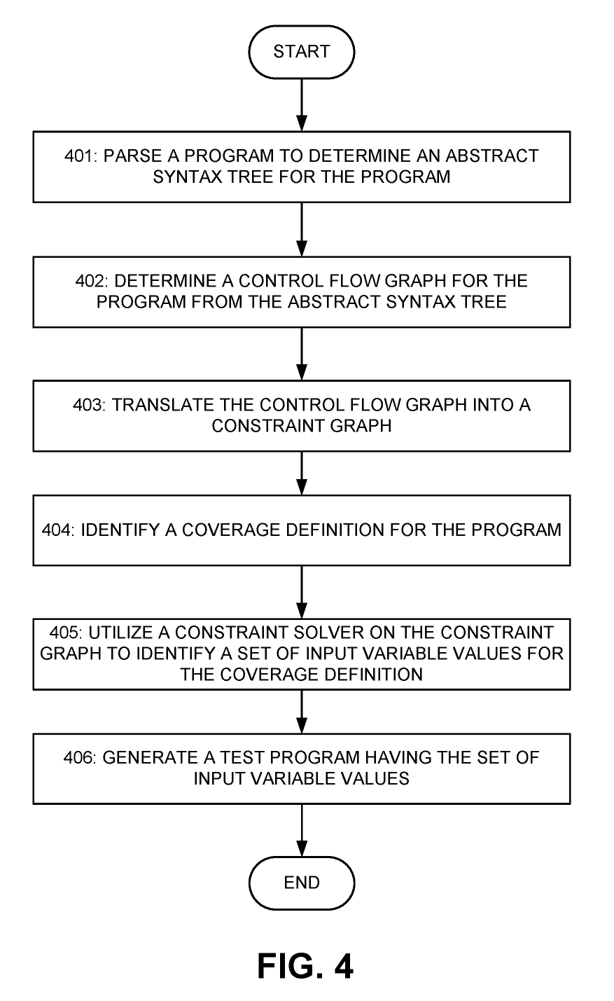

FIG. 4 illustrates a flowchart showing example test program generation based on program analysis and coverage definition according to various examples of the invention. Referring to FIG. 4, in a block 401, a computing system implementing a code analyzer can parse a program to determine an abstract syntax tree representing a syntactic structure of source code for the program. Each node of the abstract syntax tree can denote a construct occurring in the source code. The program can be written in a C or C++ programming language, a hardware description language (HDL), or the like.

In a block 402, the computing system can determine a control flow graph for the program from the abstract syntax tree. In some embodiments, the code analyzer implemented by the computing system can convert the abstract syntax tree into the control flow graph. Each node in the control flow graph 311 can correspond to a basic block in the program. The nodes in the control flow graph can have directed edges or arrows to describe a sequence of subsequent basic blocks to be executed. In some embodiments, the computing system can generate the control flow graph for the program without having to generate the intermediate abstract syntax tree or the like.

In a block 403, the computing system can translate the control flow graph into a constraint graph. In some embodiments, the computing system can traverse the control flow graph to identify portions of the program that cause transitions through different control paths, such as expressions, function calls, or the like. The constraint graph can include constraints associated with the basic blocks of the program.

In a block 404, the computing system can identify a coverage definition for the program. The coverage definition can correspond to a coverage goal for the program. For example, a coverage goal described in the coverage definition may be to cover all paths in the program or portion thereof. Another coverage goal described in the coverage definition may be to cover each line in the program or portion thereof.

In a block 405, the computing system can utilize a constraint solver on the constraint graph to identify a set of input variable values for the coverage definition. The computing system can utilize the coverage definition to identify at least one input variable value set that, when input during execution of the program, can prompt the program to execute portions of its source code that achieve the coverage goal described in the coverage definition. In some embodiments, the computing system can be a graphical-based constraint solver, such as Questa inFact™ manufactured by Mentor Graphics Corporation. Since the constraint graph reflects the structure of the program, solving for input variable values that cover the constraint graph can also be utilized during program execution to similarly cover the program.

In a block 406, the computing system can generate a test program having the set of input variable values. The test program can provide the input variable values identified by the constraint graph solver to the program. In some embodiments, the constraint graph solver can identify all of the input variable values in the input variable value set, and the test program can provide those input variable values to the program. In other embodiments, the test program can provide one or more of the input variable values to the program as the constraint graph solver identifies them. The input variable values can prompt the program, during execution, to be exercised based on the coverage definition.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### Conclusion

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to processes, it should be appreciated that various examples of the invention may be implemented using any desired combination of processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
analyzing, by a computing system, a program to generate a control flow graph representing paths capable of being traversed through the program during execution;
translating, by the computing system, the control flow graph into a constraint graph representation of the program; and
utilizing, by the computing system, a constraint solver on the constraint graph to identify a set of test values associated with a coverage definition, wherein execution of the program input with the set of test values is configured to exercise portions of the program identified in the coverage definition.

2. The method of claim 1, wherein analyzing the program further comprises:
parsing the program to generate an abstract syntax tree representation of the program; and
converting the abstract syntax tree for the program into the control flow graph representing paths capable of being traversed through the program during execution.

3. The method of claim 1, wherein the constraint graph includes nodes corresponding to constraints associated with basic blocks of the program, and includes vertexes corresponding variables in the program.

4. The method of claim 1, wherein the coverage definition is configured to identify at least one of line coverage in the program or path coverage in the program.

5. The method of claim 1, wherein translating the control flow graph into the constraint graph representation of the program further comprises:
generating a first constraint graph corresponding to a first portion of code in the program, wherein the first portion of code includes a function call to a second portion of code in the program;
generating a second constraint graph corresponding to the second portion of code; and
stitching the second constraint graph into the first constraint graph at the location corresponding to the function call.

6. The method of claim 1, further comprising generating, by the computing system, a test program that, when executed, is configured to provide the set of input variable values to the program.

7. The method of claim 6, wherein utilizing the constraint solver on the constraint graph to identify a set of test values associated with a coverage definition further comprises identifying one or more test values in the set of test values corresponding to a portion of the constraint graph, and wherein the test program is configured to provide the one or more test values to the portion of the program corresponding to the portion of the constraint graph.

8. A system comprising:
a memory device configured to store machine-readable instructions; and
a computing system including one or more processing devices, in response to executing the machine-readable instructions, configured to:
analyze a program to generate a control flow graph representing paths capable of being traversed through the program during execution;
translate the control flow graph into a constraint graph representation of the program; and
utilize a constraint solver on the constraint graph to identify a set of test values associated with a coverage definition, wherein execution of the program input with the set of test values is configured to exercise portions of the program identified in the coverage definition.

9. The system of claim 8, wherein the one or more processing devices, in response to executing the machine-readable instructions, are configured to:
parse the program to generate an abstract syntax tree representation of the program; and
convert the abstract syntax tree for the program into the control flow graph representing paths capable of being traversed through the program during execution.

10. The system of claim 8, wherein the constraint graph includes nodes corresponding to constraints associated with basic blocks of the program, and includes vertexes corresponding variables in the program.

11. The system of claim 8, wherein the coverage definition is configured to identify at least one of line coverage in the program or path coverage in the program.

12. The system of claim 8, wherein the one or more processing devices, in response to executing the machine-readable instructions, are configured to:
generate a first constraint graph corresponding to a first portion of code in the program, wherein the first portion of code includes a function call to a second portion of code in the program;
generate a second constraint graph corresponding to the second portion of code; and
stitch the second constraint graph into the first constraint graph at the location corresponding to the function call.

13. The system of claim 8, wherein the one or more processing devices, in response to executing the machine-readable instructions, are configured to generate a test program configured to provide the set of input variable values to the program.

14. An apparatus comprising at least one computer-readable memory device storing instructions configured to cause one or more processing devices to perform operations comprising:
analyzing a program to generate a control flow graph representing paths capable of being traversed through the program during execution;
translating the control flow graph into a constraint graph representation of the program; and
utilizing a constraint solver on the constraint graph to identify a set of test values associated with a coverage definition, wherein execution of the program input with the set of test values is configured to exercise portions of the program identified in the coverage definition.

15. The apparatus of claim 14, wherein analyzing the program further comprises:
parsing the program to generate an abstract syntax tree representation of the program; and
converting the abstract syntax tree for the program into the control flow graph representing paths capable of being traversed through the program during execution.

16. The apparatus of claim 14, wherein the constraint graph includes nodes corresponding to constraints associated with basic blocks of the program, and includes vertexes corresponding variables in the program.

17. The apparatus of claim 14, wherein the coverage definition is configured to identify at least one of line coverage in the program or path coverage in the program.

18. The apparatus of claim 14, wherein translating the control flow graph into the constraint graph representation of the program further comprises:
generating a first constraint graph corresponding to a first portion of code in the program, wherein the first portion of code includes a function call to a second portion of code in the program;
generating a second constraint graph corresponding to the second portion of code; and
stitching the second constraint graph into the first constraint graph at the location corresponding to the function call.

19. The apparatus of claim 14, wherein the instructions are configured to cause one or more processing devices to perform operations further comprising generating a test program that, when executed, is configured to provide the set of input variable values to the program.

20. The apparatus of claim 19, wherein the instructions are configured to cause one or more processing devices to perform operations further comprising identifying one or more test values in the set of test values corresponding to a portion of the constraint graph, wherein the test program is configured to provide the one or more test values to the portion of the program corresponding to the portion of the constraint graph.
